(19) United States
(12) Patent Application Publication
(10) Pub. No.: US 2018/0004370 A1
(43) Pub. Date: Jan. 4, 2018

(54) QUICK NAVIGATION MENU

(71) Applicant: Sony Interactive Entertainment LLC, San Mateo, CA (US)

(72) Inventors: Steven Edward Silvas, San Jose, CA (US); Michael Gross, Los Angeles, CA (US); Christopher Hebert, San Diego, CA (US); Benjamin Ackerman, Los Angeles, CA (US); Daniel Myers, San Diego, CA (US)

(21) Appl. No.: 15/638,289

(22) Filed: Jun. 29, 2017

Related U.S. Application Data
(60) Provisional application No. 62/356,049, filed on Jun. 29, 2016.

(51) Int. Cl. G06F 3/0482; G06F 3/0488; G06F 17/30

(52) U.S. Cl. CPC G06F 3/0482; G06F 17/3089; G06F 3/04883; G06F 17/30873

(57) ABSTRACT

The present disclosure describes methods and systems directed towards implementations of a quick menu. The quick menu provides a user with easy and quick access to different user interfaces, content, and/or content sources. The user can request display of the quick menu with a user input and can subsequently choose which subsequent user interface to access via displayed icons within the quick menu.

### CROSS-REFERENCE TO RELATED APPLICATIONS

This application claims the priority benefit of U.S. provisional patent application 62/356,049 filed Jun. 29, 2016, the disclosure of which is incorporated herein by reference.

### BACKGROUND

### Field of Invention

The present invention generally relates to user interfaces. More specifically, the present invention relates to quick navigation menus.

### Description of the Related Art

There are many different user interfaces that can be accessed and navigated by a user. For example, while the user is accessing a streaming service (e.g. HULU, NETFLIX, HBO GO), there may be a user interface that provides all available content that can be viewed by the user (i.e. main menu), a user interface that provides information regarding when live content may be available (i.e. program guide), and a user interface including information about the user (i.e. user profile). These different user interfaces may be mapped to corresponding inputs (e.g. buttons) that can be pulled up upon user request. For example, a user can press a first button on a remote to return to the main menu. Meanwhile a user pressing a second button on the same remote may bring up the program guide. In some situations, some user interfaces may not be directly mapped to a particular button on the remote but instead must be accessed via another user interface (e.g. accessing the user profile from within a settings user interface).

With a large number of user interfaces, finding a particular user interface may be confusing or slow. As described above, users would need to locate the user input mapped to the particular user interface. In situations where user interfaces are nested within other user interfaces, the user would need to find and navigate the appropriate user interfaces which can be time-consuming. Furthermore, with the implementation of new user interfaces, there is no current easy way to provide access to the new user interfaces to the users. Therefore, there is a need to provide an easy and efficient way for user to access different user interfaces.

### SUMMARY OF THE CLAIMED INVENTION

A method for providing a quick navigation menu is presently claimed. The method includes monitoring for a quick menu input from a user while the user views content on a computing device. The quick menu input corresponds to an activation of a pre-determined element associated with the computing device. Activation of the element will instruct the computing device to generate a quick menu for the user to view. Once the input has been confirmed, the computing device generates the quick menu for the user to view. The quick menu includes icons that correspond to different user interfaces that the user can select. When the user selects a particular icon within the quick menu, the corresponding menu will be displayed for the user to view.

A non-transitory computer-readable storage medium is also presently claimed. The storage medium includes a program that is executable by a process to perform a method for providing a quick navigation menu. The method includes monitoring for a quick menu input from a user while the user views content on a computing device. The quick menu input corresponds to an activation of a pre-determined element associated with the computing device. Activation of the element will instruct the computing device to generate a quick menu for the user to view. Once the input has been confirmed, the computing device generates the quick menu for the user to view. The quick menu includes icons that correspond to different user interfaces that the user can select. When the user selects a particular icon within the quick menu, the corresponding menu will be displayed for the user to view.

### BRIEF DESCRIPTION OF THE DRAWINGS

FIG. 1 illustrates a quick menu.

FIG. 2 illustrate implementation of the quick menu.

FIG. 3 illustrates a method for implementing the quick menu.

FIG. 4 illustrates a block diagram of an example computing device.

### DETAILED DESCRIPTION

The present disclosure describes a quick menu. The quick menu can be implemented with respect to various services (e.g. NETFLIX, HULU, HBO GO) associated with a computing device so that a user is able to access different user interfaces in an easy and quick access. The user can call up the quick menu with a user input and can subsequently choose which subsequent user interface to access without the need to 1) navigate through multiple levels of user interfaces to find a nested user interface or 2) identify which mapped user input calls up a particular user interface.

The quick menu can also be helpful in the implementation of new user interfaces. In prior art situations where there may be many different user interfaces that are mapped to particular user inputs (e.g. buttons), newer user interfaces may not be capable of being mapped. For example, a remote or controller having a preset number of user inputs (e.g. buttons) may not have available user inputs for the assignment of new user interfaces. Furthermore, the mapping of a large number of different user interfaces to different user inputs may become cumbersome if implemented via a remote or a controller.

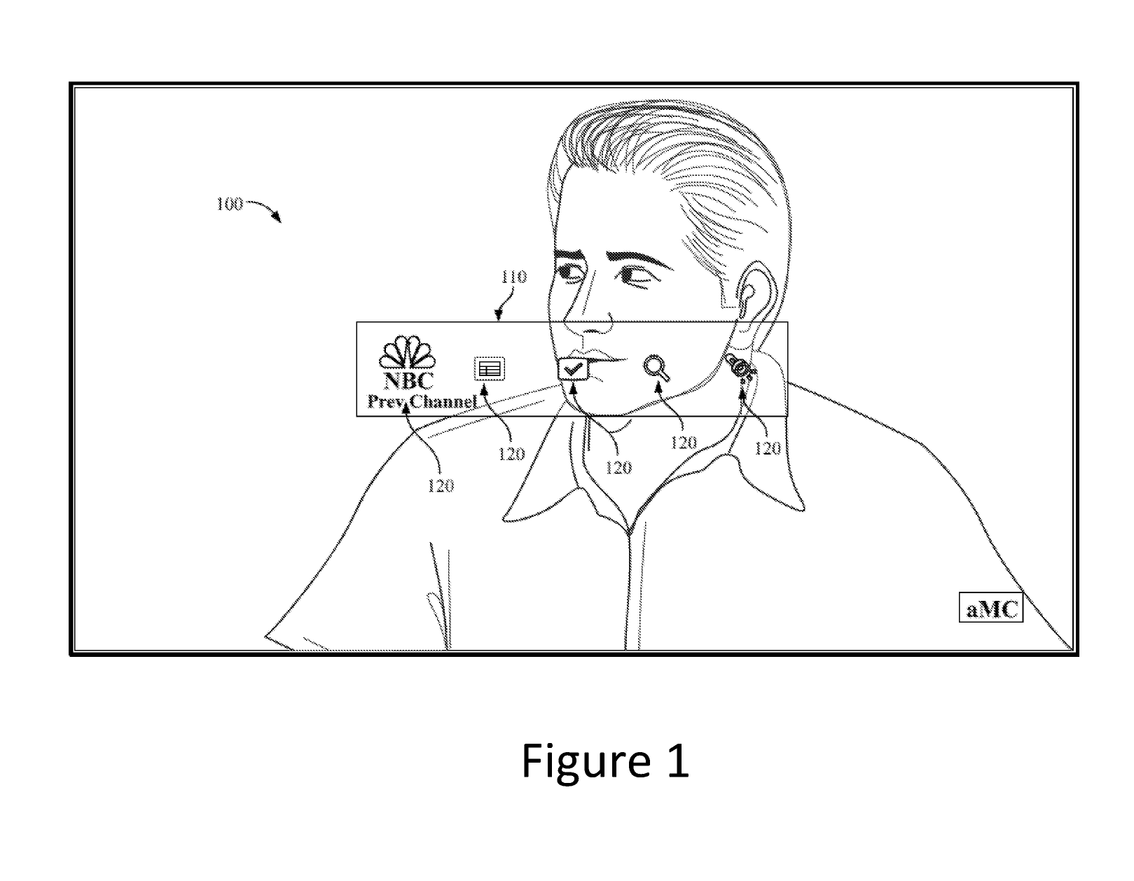

FIG. 1 illustrates a quick menu 110. In an example embodiment, the user may be viewing video content on a display associated with a computing device 100. The video content may be associated with a video streaming service. While the user is viewing the video content, the user would like to access a particular menu (e.g. program guide). Instead of trying to figure out which button pertains to the desired menu or searching through nesting menus, the quick menu 110 would facilitate the user in retrieving the appropriate menu.

The quick menu 110 would allow for the user to access any number of different user interfaces (e.g. menus) via selection of a corresponding icon 120. Each icon 120 would be mapped to a particular user interface so that selection of the icon 120 would have that user interface displayed on the computing device. Further details regarding the quick menu 110 are provided below.

To call up the quick menu 110, the user may be required to provide a user input that dictates to the computing device that the quick menu 110 should be displayed for the user. In an example embodiment, the user input may be provided via an element (e.g. button, key) on a controller, keyboard or remote. For example, there may be a designated button on a remote control that can be pressed to have the display 100 now include the quick menu 110 for the user to view.

In some embodiments, merely pressing and releasing a button may not bring up the quick menu 110. There may be situations where some buttons already have some features or functionality already mapped to the button. Therefore, the user may be required to provide the user input for a pre-determined period of time (e.g. 1 second). This would correspond to the user pressing and holding down on the button for a period of time so that the computing device is instructed to display the quick menu 110.

In further embodiments, the user may be required to press and hold the button down on the remote until the quick menu 110 is displayed by the computing device. To help inform the user regarding when the quick menu 110 may be displayed, there may be a progress bar associated with the display of the quick menu 110 illustrating a progression until the quick menu 110 is displayed. As the user presses and holds the button, an empty progress bar may fill from left to right. When the progress bar is filled completely, this may notify to the user that the quick menu 110 will be displayed shortly. Instructions to the computing device to begin generating the quick menu may be provided simultaneous to the completion of the progress bar.

It should be noted that the different methods for how to call the quick menu 110 for display can be customized. For example, users and/or administrators may customize what buttons are mapped to the quick menu, the conditions (e.g. length of time for the user input), as well as any notification (e.g. progress bar) are used.

As illustrated in FIG. 1, the quick menu 110 is displayed in a central location on the display 100. The quick menu 110 also has a particular size that does not take up the entire display 100. The shape of the quick menu 110 can also be customized. The quick menu 110 also has an opaqueness feature that allows the user to still view the video content in the display 100 behind the quick menu 110. The example illustrated in FIG. 1 may be associated with a default setting dictating how the quick menu 110 is displayed. However, these features of the quick menu 110 can also be customized.

In different embodiments, the quick menu 110 can be assigned a different location (e.g. upper right hand corner of the display), be provided a different size, be provided a different shape and/or provided different opaqueness features that can prevent the user from viewing through the quick menu 110. Each of these features can be customized based on user preference. For example, perhaps the user would like to have the quick menu 110 displayed away from the center of the display so as to not interfere with what is being viewed on the display 100. The quick menu 110 may also be provided a larger or smaller area of coverage based on how many icons 120 are included in the quick menu 110. Finally, the quick menu 110 may also be opaque so that underlying display of video content does not interfere with the icons 120 within the quick menu 110. These features may be customized via a settings menu that may also be represented by an icon 120.

As described herein, the settings menu may be a menu that includes different parameters dictating how the quick menu 110 is displayed and/or operates. There may be different parameters that can be set and modified by the user to influence how the quick menu 110 is displayed and/or operates. For example, the location, size, opaqueness of the quick menu 110 may be controlled here. Other example features of the setting menu would allow for customization of the icons used within the quick menu 110. In general, if there are any features regarding the quick menu 110 that can be customized described within this application, the ability to control how that feature of the quick menu 110 can be found within the setting menu.

As illustrated in the figure, the quick menu 110 includes a plurality of different icons 120. For example, the quick menu 110 may include five different icons lined up in a single horizontal row. The icons 120 may be assigned a pre-determined size based on the size of the quick menu 110. Furthermore the icons 120 may also be arranged based on the size of the quick menu 110.

The display of the icons 120 may also be customized. For example, the icons 120 can also be arranged in a single vertical row if the quick menu 110 is provided with a similar rectangular vertical shape. In situations where more icons are possible, the icons may be arranged in multiple rows or columns resembling a two dimensional table. For example, the user could dictate that when ten icons are available, a table having two rows and five columns can be used instead of having a quick menu having ten elements lined up horizontally. The display and arrangement of the icons 120 can also be customized via the setting menu.

It should be noted that how the icons appear to the user can also be customized via the settings menu. For example, the size of the icons, how the icons are highlighted, and how much space is provided between consecutive icons can be adjusted.

With the example in FIG. 1, the quick menu 110 includes example icons 120 that represents user interfaces for a program guide, a list of user favorited shows, and search/explore features. These user interfaces may be common with many known content streaming services. Instead of having to press individual buttons or navigating through different menus to access these user interfaces, the quick menu 110 can provide easy and quick access to these three different example user interfaces.

As referenced above, the different icons 120 correspond to different user interfaces that the user can access and navigate within. The icons 120 that are used to represent the different user interfaces are generally pre-determined/pre-set, for example, by the manufacturer. In embodiments where icons can represent different content (e.g. shows, movies) or sources of content (e.g. television station channel), the icons 120 may be set by the source of the content. Even so, it may be possible that the user can customize what icons 120 could be used and associated with respect to a user interface, content, or content source. Such customization may be possible via the settings menu.

As described herein, user interfaces correspond to different menus that can be accessed and navigated with respect to the computing device. For example, some user interfaces may include user profiles, program guides, and setting menus. These user interfaces may include information and features that the user could view separate from the content currently being viewed on the computing device.

Content, as used herein, refers to any sort of program (e.g. shows, movies) that can be viewed on the computing device. On the other hand, content sources are used to refer to the where the content may be found. For example, a content source may include a television station channel or cable service that store and provide content (e.g. live television program, movie) for the user to view on the user device.

Many times icons 120 used to represent these different user interfaces may be set by the service provider. Generally icons are selected so that users (at a glance) can interpret and understand what the icon 120 would be linked to without additional assistance. For example, some icons 120 may generally be recognized as a setting configuration menu or user profile if used consistently across different services. However, in situations where icons 120 are not easily understood, additional information (e.g. text) can be associated with the icons 120 and provided when requested to help inform what each icon 120 represents.

As described above, the quick menu 110 may provide additional description (e.g. text) that provides information to the user what user interface the icon 120 corresponds to. In this way, the user can know what user interface is being selected via their associated icon 120. The descriptions associated with the icons 120 may be available at all times for the user to view while the quick menu 110 is displayed. However, in situations where there are many icons 120 displayed or there is a desire for less to be displayed, text associated with the icons 120 may only be displayed when the particular icon 120 is highlighted or selected. The customizable conditions which describe how the descriptions may be displayed can be established via the settings menu.

With the different icons 120 within the quick menu 110, users are able to navigate between different icons 120 within the quick menu 110 via user inputs associated, for example, with a controller or remote. For example, the controller or remote may include directional buttons that allows the user to switch from one icon 120 to another icon. When the quick menu 110 is initially displayed, a first icon may be initially highlighted. Highlighted icons represent a current icon that the user can select to request the corresponding user interface. Highlights can correspond to enlarging of the icon (compared to the other icons), inclusion of color (where non selected icons are black/white), use of a cursor, or a change in an area surrounding the icon. As described above, text can also be displayed when an icon is being highlighted.

When the desired icon 120 is highlighted, the user may provide another user input (e.g. button press) that dictates that the highlighted icon 120 is selected. In some situations, the button press may be for a pre-determined period of time (e.g. one second). Selection of an icon 120 would correspond to user indication that the computing device should display the associated user interface corresponding with the selected icon.

The icons 120 included in the quick menu 110 may be pre-set, for example, by the service or computing device. The quick menu 110 may include icons 120 at least a program guide, list of saved or user favorited content, and setting menu. However, the icons 120 may also be customized for each user experience. In some situations, the icons 120 may correspond the user interfaces that the user accesses frequently or has last accessed within a pre-determined period of time (e.g. within the last hour). Furthermore, other situations may include providing the user with the ability to customize what icons 120 should be included in the quick menu for easy and quick access to corresponding user interfaces.

The quick menu 110, through the use of icons 120, may also be used to provide quick and easy access to different content sources (e.g. channels). For example, channels that the user “favorites” or views frequently (within a pre-determined period of time) can be included in the quick menu 110 automatically or by user choice. Furthermore, the “last” channel(s) can also be included so that the user is able to return to previous channels quickly without the need to surf/navigate through many different channels.

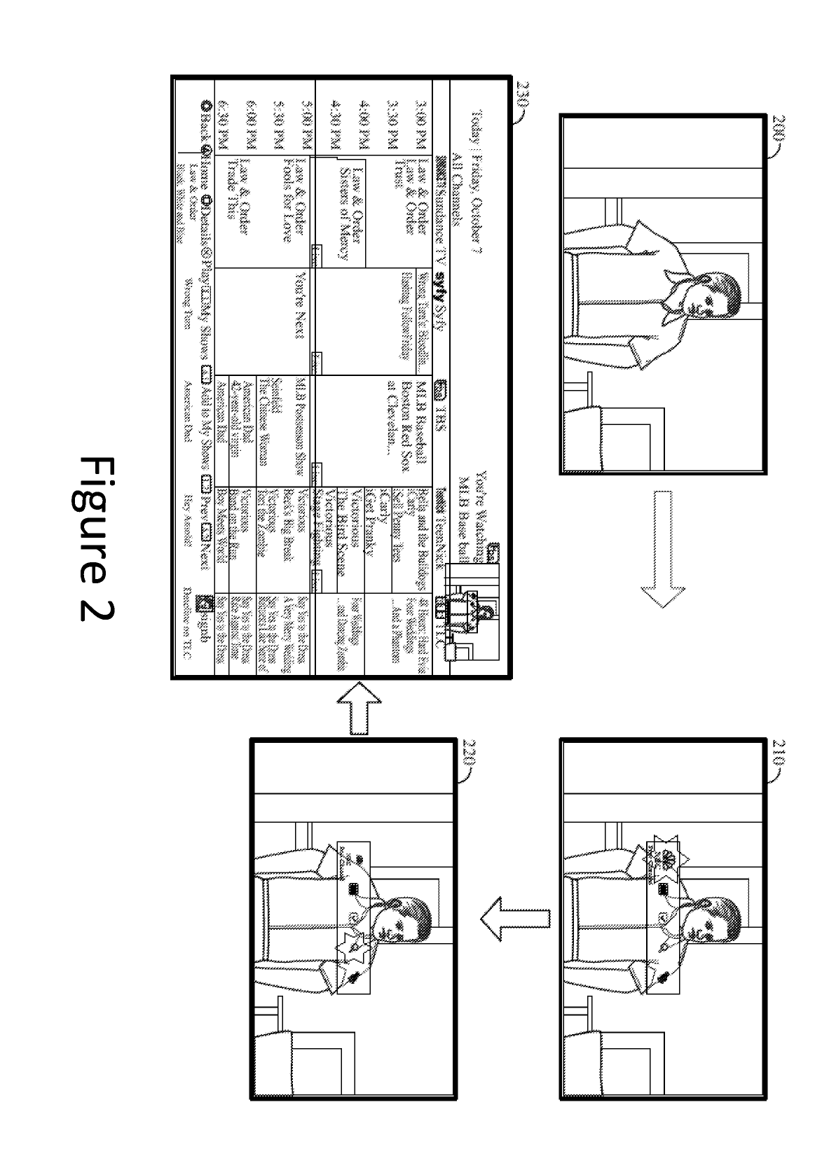

FIG. 2 illustrate an implementation of the quick menu. In particular, the implementation describes how the quick menu of FIG. 1 may be implemented from a computing device (e.g. console, mobile device, desktop, laptop).

The user may initially be viewing content (e.g. video content) on the computing device 200. At any time, the user may be interested in accessing a user interface (e.g. program guide, settings menu, user profile). To request that the quick menu be displayed, a user input may be provided. Such user inputs can be provided, for example, via keys on a corresponding keyboard or buttons on a corresponding remote or controller. As described above, there may be specific user inputs mapped to the request for the quick menu. There may also be conditions associated with the user input (e.g. providing an input for a pre-determined period of time).

Once the user has provided the required user input for the quick menu, the computing device begins executing instructions directed towards the generation of the quick menu on the display. As noted above, the quick menu may take into account user viewing history of various user interfaces and/or content sources when generating the quick menu.

What is displayed on the quick menu with respect to the icons used in the quick menu may be retrieved from a database. In one embodiment, the icons used for specific user interfaces or content may be initially stored on a third party server associated with the service (e.g. HULU). Such data can be provided to the computing device and stored locally. The computing devices can utilize this information for the icons so that icons used in quick menus across different users are consistent (i.e. the same icon for program guide is replicated across different computing devices). However, it may be possible that different services can utilize different icons.

In other cases, a common mapping of icons can be associated with the computing devices. For example, different services may have their own program guides regarding information for available content for the user to view. Each service may have their own icons for representing the program guide in the quick menu. The common mapping of icons can utilize one icon (either icon from the services or a different third icon) for all associated program guides. In this way, the user is able to consistently have the same icons used with the quick menu thereby making the icons recognizable across different services.

After generating the quick menu, the computing device can display the quick menu for the user to view 210. As illustrated in the figure, the quick menu may be situated in the middle of the display with multiple icons representing different user interfaces or content sources the user would like to access. With the initial display of the quick menu, an icon may be initially highlighted for selection.

Although the figure illustrate the quick menu as being located in the middle, with five icons and having an opaqueness feature that allows the user to view the video content behind the quick menu, it should be noted that the user (or others such as an administrator associated with the viewing service) can customize the placement and properties of the quick menu. For example, the quick menu can be placed on the left or right side of the display so as to provide less interference with the video content on display.

Once the quick menu is displayed, the user is able to navigate through the quick menu in order to select a particular icon in the quick menu 220. The navigation can be performed via user input, for example, via the keyboard, controller, or remote that was used to request display of the quick menu. The navigation of the quick menu can be implemented a number of different ways. For example, direction arrows can be used to instruct which icon to highlight. As noted above, highlighted icons can be indicated using enlarged icons, colors, or cursors. At least with reference to 210 and 220, a cursor (e.g. shape) is used to identify the currently selected icon.

A track ball, track pad, or mouse can also be used to provide user input regarding which icon should be selected. In each of these situations, a user can indicate a particular icon by moving the highlighted area left or right until it arrives at the desired icon. Once the desired icon is selected, a different user input can be provided to signify to the computing device the user interface or content to display.

In a further embodiment, a single button can also be used to scroll to a “next” icon. The highlighted icon may initially rest on a first (left most) icon. With each press of the single button, the highlighted icon becomes the next (i.e. right) icon. When the last (right most) icon is selected and the single button is pressed again, the highlighted icon can reverse one spot (e.g. move left one spot) or return back to the first (left most) icon. Once the desired icon is selected, the user may select the icon via a different button. Alternatively, the user may press and hold the single button for a pre-determined period of time to indicate selection.

In the embodiment using a single button to navigate and select icons, thresholds of how long the user presses the single button can be used to differentiate between navigation between icons in the quick menu and selection of the icon within the quick menu. For example, a user input of less than a second can indicate that the user wishes to navigate within the quick menu (i.e. to the next icon). With a user input that is greater than 3 seconds, this may be indicative that the user wishes to select the highlighted icon.

Once a highlighted icon has been selected, the computing device can then display the corresponding user interface or content for the user to view 230. The user interface would replace the video content previously displayed on the computing device. In some embodiments, a smaller version of the video content can be provided in a portion of the display for the user to view whenever a user interface is called up. For example, if the user wishes to access the program guide, setting menu, or user profile, the computing device can provide the requested user interface alongside a smaller display of the video content that was previously displayed (see 200). However, if the user wishes to access a different content (e.g. show) or content source (e.g. channel), the modified display may not be provided.

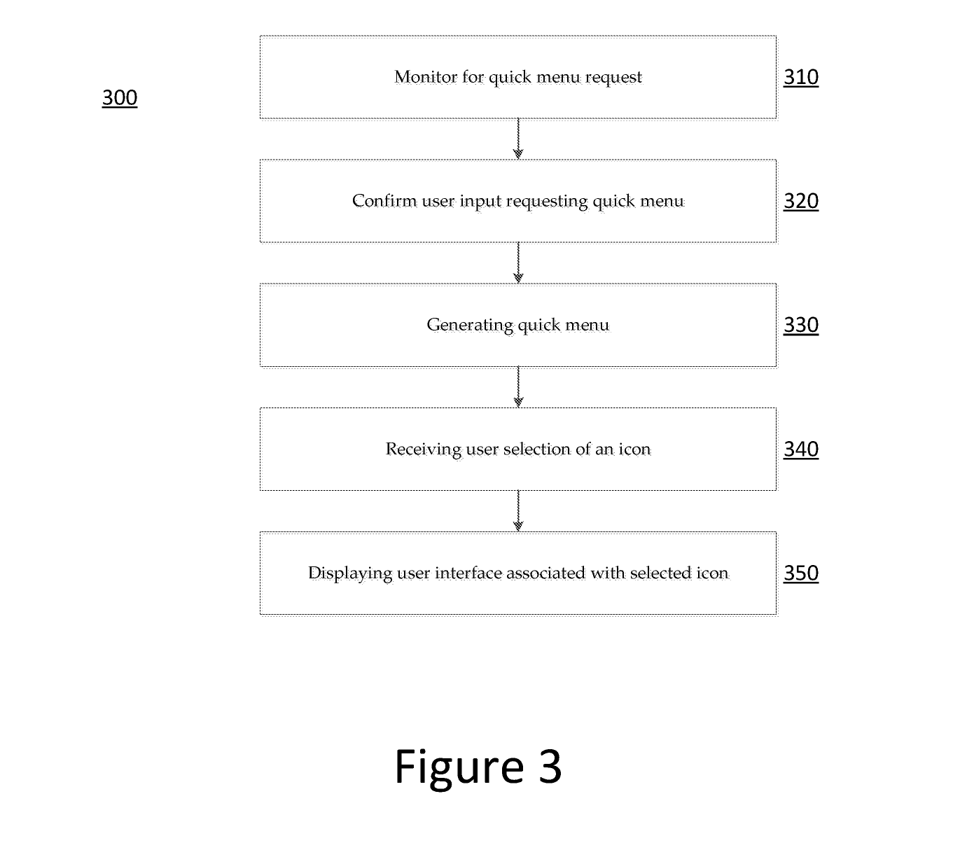

FIG. 3 illustrates a method 300 for implementing the quick menu. The quick menu allows the user to search for and navigate different user interfaces, content, or content sources easily and quickly.

In step 310 the computing device may be monitoring for user input corresponding to a request for the quick menu. In an embodiment, the user may be viewing video content (e.g. movie, television show) on the computing device. The user, at any time, may desire to view a particular user interface (i.e. menu) or another content (e.g. program) or content source (e.g. channel). To call up the quick menu, the user may be required to activate an element (e.g. button) associated with the computing device. The button may be associated, for example, with a keyboard, remote, or controller associated with the computing device.

In some embodiments, the user may be capable of providing vocal commands to the computing device in order to call up the quick menu. For example, the computing device may have a microphone or some other audio-based sensor that receives user vocal commands. If the user's vocal command corresponds to a pre-determined word or phrase that corresponds to the quick menu, instructions to the computing device can be generated that instruct the computing device to generate and display the quick menu.

It may also be possible that gestures can also be captured via cameras associated with the computing device to also call up the quick menu. For example, a pre-determined gesture performed by one or both hands of the user can also be used to instruct the computing device to generate and display the quick menu.

Once user inputs have been detected (e.g. whether the input is associated with a remote, vocal command, or gesture), the computing device can confirm whether the detected user input corresponds to the quick menu in step 320. There may be many other different user inputs that may be associated with the computing device that can be provided via the remote, as vocal commands, or via gestures. For example, there may be commands that can instruct the computing device to switch programs, turn off the computing device, or adjust the sound levels. Therefore, the user inputs would be compared against a database of recognized/known inputs. If the user input matches with one of the recognized/known inputs associated with the quick menu, the computing device would be instructed to begin generation of the quick menu.

In step 330, the computing device generates the quick menu for the user to view. The quick menu is generated based on pre-determined parameters such as its size, location on the display, and opaqueness. These parameters may be customized via the user using the settings menu. The quick menu may therefore have a default setting as well as user-customized settings that are stored on the computing device.

The quick menu may include any number of icons that correspond to different user interfaces (e.g. menus), content (e.g. movies, programs), or content sources (e.g. channels). For example, the quick menu for all computing devices may always display icons for the program guide, user settings, and user profile. Other icons that are included in the quick menu may be based on frequency of use or viewing of a particular user interface, content, or content source. Other icons may also be included based on the last used or viewed (or most recently used or viewed) user interface, content, or content source.

What icons should be displayed in the quick menu for the user may be determined at the computing device and stored locally. As noted above, some icons displayed in the quick menu may be based on user history (e.g. recently viewed/accessed user interfaces, content, or content sources). Other icons may be pre-set by the computing device (i.e. manufacturer). It may also be possible that the user assigns some number icons to always appear within the quick menu as well. In this way, the quick menu can be customized for each user (or user account) or each computing device.

In step 340, user selection regarding one of the icons within the quick menu is received. Icons would become highlighted to inform the user which of the icons would potentially being selected. As described above, icons can be highlighted any number of different ways. For example, the icon can be displayed in color, be provided with a different colored background, and/or enlarged compared to the other icons. This allows for a differentiation between the selected icon and the other icons not currently being selected.

Navigation and selection of an icon is performed, for example, via an assignment elements (e.g. buttons) associated with the computing device. For example, the buttons may be associated with a keyboard, remote, or controller associated with the computing device.

In other embodiments, vocal commands may be detected to also navigate or select an icon. For example, voice commands detected via a microphone or other audio-based sensor associated with the computing device (i.e. “next”, “select”) could be used to navigate and/or select an icon.

Furthermore, a camera can be used to identify gestures provided by the hands of the user to identify which icon could be selected. A first set of gestures could be used to navigate through the quick menu while a separate gesture could be used to confirm selection of an icon. It should be noted that the camera could also be used to monitor the gaze of the user and pinpoint which icon the user may be potentially looking at. If the desired icon is highlighted, the user can confirm selection of the icon via any of the above methods (e.g. pressing a button, vocal command, gesture).

In step 350, the computing device retrieves the corresponding user interface, content or content source in connection with the user selected icon. In doing so, the quick menu is terminated and the current display of content may be replaced. For example, if a different content or content source was selected via an icon in the quick menu, the selected content (e.g. show) or content source (e.g. channel) would replace what was previously displayed on the computing device. If a user interface was selected, this may also replace what was previously displayed. However, as described above, there may be embodiments where the user would still be able to view the user interface and the video content simultaneously.

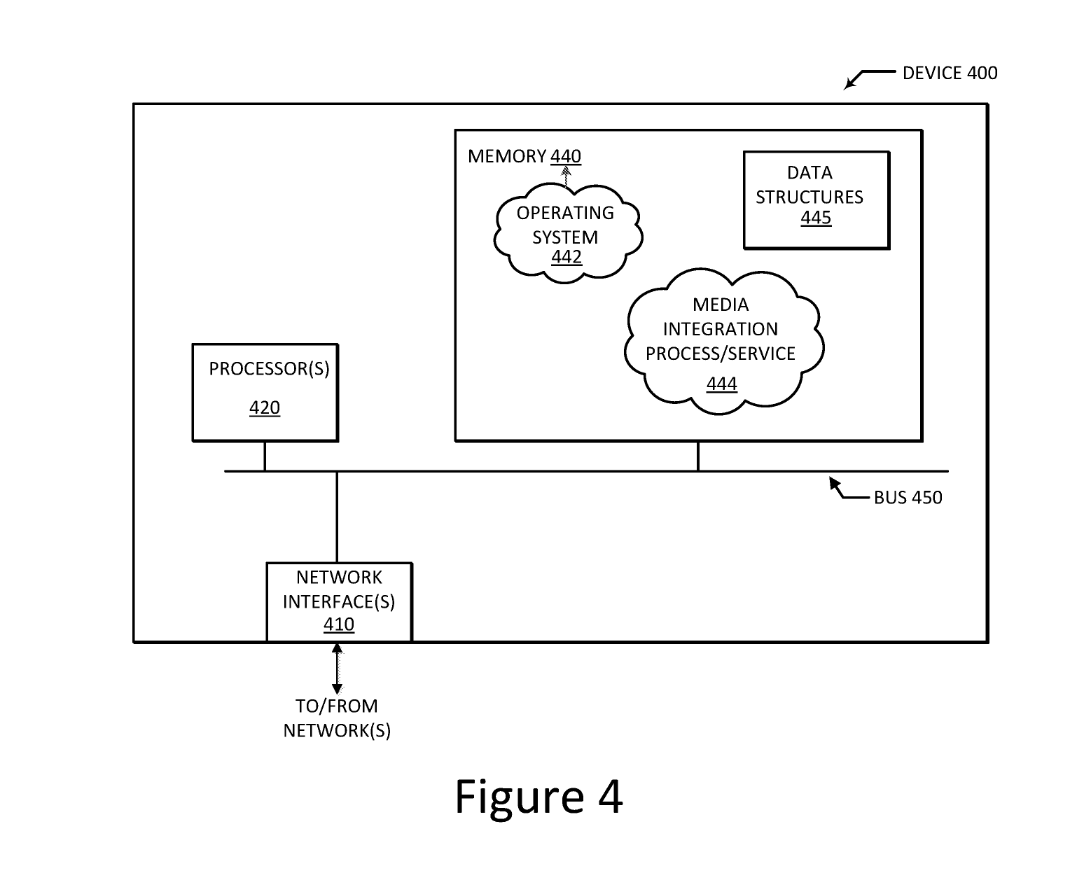

FIG. 4 illustrates a block diagram of an example computing device 400. The exemplary computing device 400 (e.g., desktop, laptop, tablet, mobile device, console gaming system) is a device that the user can utilize to facilitate carrying out features of the present invention. As shown, device 400 includes one or more network interfaces 410 (e.g., transceivers, antennae, etc.), at least one processor 420, and a memory 440 interconnected by a system bus 450.

Network interface(s) 410 contain the mechanical, electrical, and signaling circuitry for communicating data over links coupled to one or more networks. Network interfaces 610 are configured to transmit and/or receive data using a variety of different communication protocols, as will be understood by those skilled in the art.

Memory 440 comprises a plurality of storage locations that are addressable by processor 420 for storing software programs and data structures associated with the embodiments described herein. For example, memory 440 can include a tangible (non-transitory) computer-readable medium, as is appreciated by those skilled in the art.

Processor 420 may comprise necessary components, elements, or logic adapted to execute the software programs and manipulate data structures 445, which are stored in memory 440. An operating system 442, portions of which are typically resident in memory 440, and is executed by processor 420 to functionally organize the device by invoking operations in support of software processes and/or services executing on the device. These software processes and/or services may comprise an illustrative “media integration” process/service 444. Note that while process/service 444 is shown in centralized memory 440, the process/service may be configured to operate in a distributed communication network.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 420 can include one or more programmable processors, e.g., microprocessors or microcontrollers, or fixed-logic processors. In the case of a programmable processor, any associated memory, e.g., memory 440, may be any type of tangible processor readable memory, e.g., random access, read-only, etc., that is encoded with or stores instructions that can implement program modules, e.g., a module having spectator channel process 444 encoded thereon. Processor 420 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed:

1. A method for providing a quick navigation menu, the method comprising:
monitoring for a quick menu input from a user while the user views content on a computing device, the quick menu input comprising of an activation of a pre-determined element associated with the computing device, wherein the quick menu input instructs the computing device to generate a quick menu for the user to view;
confirming that the quick menu input has been received by the computing device;
generating the quick menu for the user to view in response to the confirmation, wherein the generated quick menu includes a plurality of icons that correspond to a plurality of different user interfaces;
receiving user selection of one of the icons in the quick menu; and
providing the user menu corresponding to the selected icon from the quick menu for the user to view.

2. The method of claim 1, wherein the quick menu input further includes the activation of the pre-determined element for a pre-determined period of time.

3. The method of claim 2, wherein a progress bar is provided for the user to view indicating how much longer the activation needs to be performed before the computing device is instructed to generate the quick menu.

4. The method of claim 1, wherein the pre-determined element is a button on one of a keyboard, remote, or controller associated with the computing device.

5. The method of claim 1, wherein the generated quick menu also includes icons that correspond to a plurality of different content.

6. The method of claim 1, wherein the generated quick menu also includes icons that correspond to a plurality of different content sources.

7. The method of claim 1, wherein the quick menu can be further customized by the user, the customization including modifying one or more of a location, size, and opaqueness of the quick menu.

8. The method of claim 7, wherein the customization further includes dictating an arrangement of how the icons are displayed within the quick menu.

9. The method of claim 1, wherein the generated quick menu also includes icons corresponding to user interfaces, content, or content sources that have recently been viewed by the user.

10. The method of claim 1, wherein the user selection of the icons is provided via a second pre-determined element, the second pre-determined element being a second button associated with one of a keyboard, remote, or controller.

11. The method of claim 1, further comprising navigating the quick menu in order to select a desired icon, wherein the navigation is performed via one of a keyboard, remote, or controller associated with the computing device.

12. The method of claim 1, wherein the icons included in the quick menu also correspond to a content or a content source that the user can view on the computing device.

13. The method of claim 12, wherein the content source includes a television station channel.

14. The method of claim 12, wherein the content includes a live television program or movie.

15. A non-transitory computer-readable storage medium having embodied thereon a program, the program being executable by a processor to perform a method for providing a quick navigation menu, the method comprising:
monitoring for a quick menu input from a user while the user views content on a computing device, the quick menu input comprising of an activation of a pre-determined element associated with the computing device, wherein the quick menu input instructs the computing device to generate a quick menu for the user to view;
confirming that the quick menu input has been received by the computing device;
generating the quick menu for the user to view in response to the confirmation, wherein the generated quick menu includes a plurality of icons that correspond to a plurality of different user interfaces;
receiving user selection of one of the icons in the quick menu; and
providing the user menu corresponding to the selected icon from the quick menu for the user to view.
